(19) United States
(12) Patent Application Publication
(10) Pub. No.: US 2010/0052493 A1
(43) Pub. Date: Mar. 4, 2010

(54) RARE GAS DISCHARGE LAMP APPARATUS

(75) Inventors: Masaharu Otsuka, Hyogo (JP); Yoshihiro Kanahashi, Hyogo (JP); Yoshihisa Yokokawa, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: Ushio Denki Kabushiki Kaisha, Tokyo (JP)

(21) Appl. No.: 12/550,721

(22) Filed: Aug. 31, 2009

(30) Foreign Application Priority Data
Aug. 29, 2008 (JP) 2008-221644

(51) Int. Cl. H01J 61/94

(52) U.S. Cl. 313/1

(57) ABSTRACT

A rare gas discharge lamp apparatus has two or more rare gas discharge lamps aligned in parallel, each of which has a glass bulb that contains rare gas therein and first and second external electrodes that are formed on an outer surface of the glass bulb, extends in a glass bulb length direction, and are arranged apart from each other. The first and second external electrodes are made from metallic foils, and project in an outer length direction of the glass bulb from the respective glass bulbs to form extended portions. In addition, the first external electrode of one of the two or more rare gas discharge lamps and that of another one of the two or more rare gas discharge lamps are joined by a pressure bonding member at the extended portions of the respective first external electrodes.

### CROSS-REFERENCES TO RELATED APPLICATION

This application claims priority from Japanese Patent Application Serial No. 2008-221644 filed Aug. 29, 2008, the contents of which are incorporated herein by reference in its entirety.

### TECHNICAL FIELD

The present invention generally relates to a rare gas discharge lamp apparatus in which two or more rare gas discharge lamps are integrally formed as one unit, and more particularly to a rare gas discharge lamp apparatus suitable for a light source for exposure in a copying machine, an image scanner, etc. or a light source for back light.

### BACKGROUND

A rare gas discharge lamp having external electrodes is suitably used as a light source for exposure in a copying machine, an image scanner, etc. In such an external electrode type rare gas discharge lamp, a phosphor layer is formed on an inner circumference face of a tubular glass bulb thereof, except for an opening for optical projection, which is formed along a tube axis direction, and after xenon gas which contains rare gas as a main component is enclosed at a certain charged pressure therein, both ends thereof are sealed. Further, a pair of electrodes which have almost the same length as that of the glass bulb is attached on an outer circumferential surface of the glass bulb, and a translucent resin for coating these electrodes, which has high insulating property, is deposited on an outer surface thereof. As described in, for example, Japanese Patent Application Publication No. 2004-134167 etc., in recent years, a light exposure unit having two rare gas discharge lamps has been developed in order to prevent bad effect to a printing state due to a projected ink on an original document etc.

FIG. 7 is a cross sectional view of an example of a general structure of a scanner, taken perpendicularly to axes of light bulbs, in case where an external electrode type rare gas discharge lamp is used as an exposing light source of a lighting apparatus in a copying machine, an image scanner, etc. In two rare gas discharge lamps 71a and 71b which have the same structure as each other, a pair of electrodes 75a and 76a and a pair of electrodes 75b and 76b, each of which faces each other, are disposed on the respective outer circumferential surfaces of the glass bulbs. In this apparatus, the two rare gas discharge lamps 71a and 71b are arranged in parallel under a contact glass 77, and irradiates a face of an original document 78 with light from two directions. Reflected light is read out by a charge coupled device CCD (Charge Coupled Device) which is provided under a middle part sandwiched between the rare gas discharge lamps 71a and 71b. In such an apparatus, in order to attain a low power operation, power is fed from one power supply to the two rare gas discharge lamps 71a and 71b.

In Japanese Patent Application Publication No. 2005-056663, a wiring path of a two lamp type rare gas discharge lamp unit is disclosed. FIG. 8 is an explanatory diagram of such a rare gas discharge lamp apparatus disclosed in the Japanese Patent Application Publication No. 2005-056663. More specifically, FIG. 8 is a top plan view thereof, wherein end portions of terminals for electric supply of the two lamp electrode type fluorescence lamp are soldered. In the structure of this unit, a terminal 80a for electric supply and a lead wire 73a are connected to each other by a solder 72a, and terminals 80b and 80b for electric supply of both rare gas discharge lamps are connected to each other by a solder 72b together with a lead wire 73b. These terminals for electric supply are 10-50 mm in length, and a distance between the two external electrode type fluorescence lamps 71a and 71b is set to 5-50 mm. Moreover, respective end portions of terminals 80c and 80c for electric supply of the respective rare gas discharge lamps 71a and 71b are connected to each other by solder 72c.

With a miniaturization of such a light source unit, the diameter of a glass bulb is becoming small. As a result, the structure of such external electrodes may become small in width, and glass bulbs of, for example, 1 mm or less in width have been manufactured. Thus, if the width of external electrodes becomes small (narrow), the workability thereof becomes bad at the time these terminals are connected to the external electrodes, thereby producing poor connection. Moreover, in the technology disclosed in the above described Japanese Patent Application Publications, although terminals for electric supply are electrically joined to each other with a solder, there is a problem that the workability thereof is bad and connection strength cannot be obtained.

### SUMMARY

It is an object of the present invention to offer a rare gas discharge lamp apparatus in which the two or more rare gas discharge lamps are arranged in parallel, and in which voltage is simultaneously impressed to two or more lamps, wherein the reliability of an electric joint of the structure of an electric supply section is high, and further it is easily manufactured and the yield thereof is good.

In order to solve the above problem, in the present rare gas discharge lamp apparatus, two or more rare gas discharge lamps are aligned in parallel, each of which has a glass bulb that contains rare gas therein and first and second external electrodes that are formed on an outer surface of the glass bulb, extends in a glass bulb length direction, and are arranged apart from each other, wherein the first and second external electrodes are made from metallic foils, and project in an outer length direction of the glass bulb from the respective glass bulbs to form extended portions, and wherein the first external electrode of one of the two or more rare gas discharge lamps and that of another one of the two or more rare gas discharge lamps are joined by a pressure bonding member at the extended portions of the respective first external electrodes.

Since the metallic foils which form electrodes are formed so as to be longer than the length of the glass bulb, and the electrodes projected from the glass bulb are joined to each other by the pressure bonding member, it is possible to produce the rare gas discharge lamp apparatus which is easy to manufacture and in which the productivity thereof is good, while the reliability of electric junction is high.

In addition, in the rare gas discharge lamp apparatus, the first external electrode of each of the two or more rare gas discharge lamps may have a step portion where a narrow part whose width is shorter than the other part, is formed at the extended portion, and the first electrodes are joined at the narrow parts by the pressure bonding member.

In such a rare gas discharge lamp apparatus, since the narrow part is formed in a predetermined position of the electrodes itself, and since at the time of pressure bonding, the step portion of the wide part thereof is brought into contact with the reference face of the metallic mold, these external electrodes can be joined by bonding together with the pressure bonding member always in the fixed position, so that the connection position does not vary. Therefore, when these two lamps are installed in an apparatus casing after connecting these electrodes, it is possible to eliminate a problem that the apparatus cannot be assembled certainly because a connection position varies.

In such a rare gas discharge lamp apparatus, a reinforcing member made of resin may be formed on one face of the metallic foil forming the external electrode, through an adhesive agent layer, and a non adhesive side face of the reinforcing member of the first external electrode of the one of the two or more rare gas discharge lamps and that of the reinforcing member of the another one of the two or more rare gas discharge lamps may be brought into contact with each other and then the first external electrodes are joined by the pressure bonding member.

In such electrodes, since the reinforcing member is provided through the adhesive agent layer, even if these electrodes are small in width, such as the width thereof is 1 mm or less, it is hard to be torn to pieces, whereby the rare gas discharge lamp apparatus may be formed so that management thereof becomes easy, and the yield thereof is good and productivity thereof is high.

Moreover, in such a rare gas discharge lamp apparatus, the reinforcing member is made of resin whose thickness may be 25-75 μm.

### BRIEF DESCRIPTION OF DRAWINGS

Other features and advantages of the present rare gas discharge lamp apparatus will be apparent from the ensuing description, taken in conjunction with the accompanying drawings, in which:

FIG. 1 is a perspective view of an overall rare gas discharge lamp apparatus according to the present invention;

FIG. 2A is a top plan view thereof;

FIG. 2B is an enlarged cross sectional view of a circled portion of FIG. 2A, taken along a line 2B-2B of FIG. 2A;

FIG. 2C is an enlarged top plan view thereof, which is viewed from a direction B of FIG. 2B;

FIG. 3A is an explanatory perspective view of a manufacturing process of a rare gas discharge lamp apparatus, wherein external electrodes are shown;

FIG. 3B is an enlarged cross sectional view of an electrode portion;

FIG. 4 is an explanatory diagram of a manufacturing process of a rare gas discharge lamp according to the present invention;

FIG. 5 is a cross sectional view of a rare gas discharge lamp according to the present invention;

FIGS. 6A and 6B are explanatory diagrams of a manufacturing process of a rare gas discharge lamp according to the present invention;

FIG. 7 is a cross sectional view of a scanner using a rare gas discharge lamp apparatus in the technical field of the present invention; and

FIG. 8 is an explanatory top plan view of a conventional rare gas discharge lamp apparatus.

### DETAILED DESCRIPTION

A description will now be given, referring to embodiments of the present rare gas discharge lamp apparatus. While the claims are not limited to such embodiments, an appreciation of various aspects of the present rare gas discharge lamp apparatus is best gained through a discussion of various examples thereof.

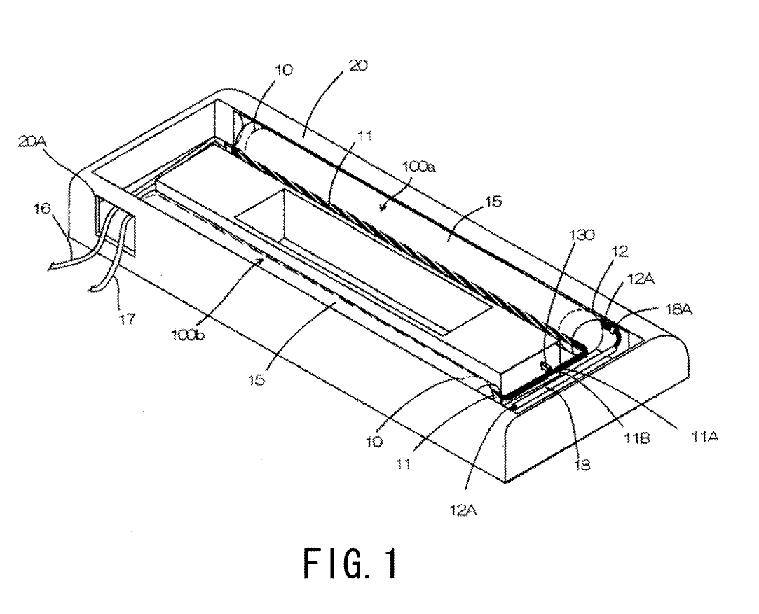

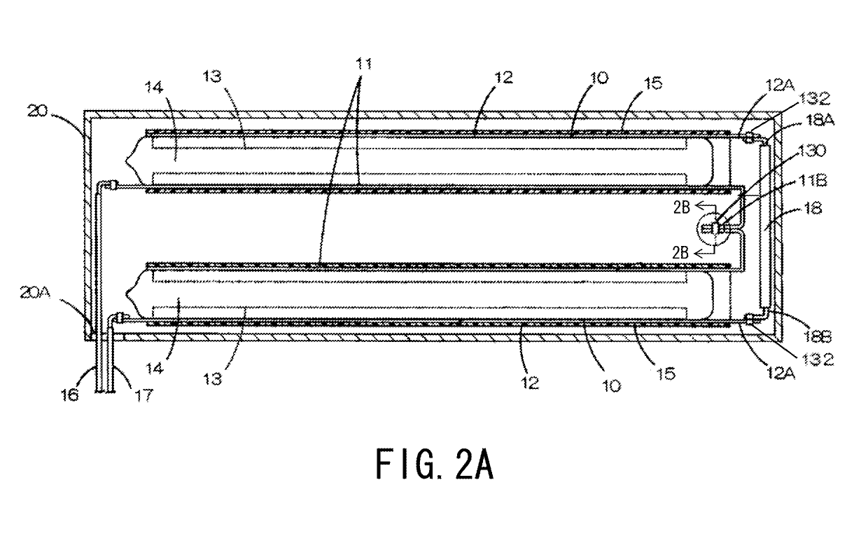

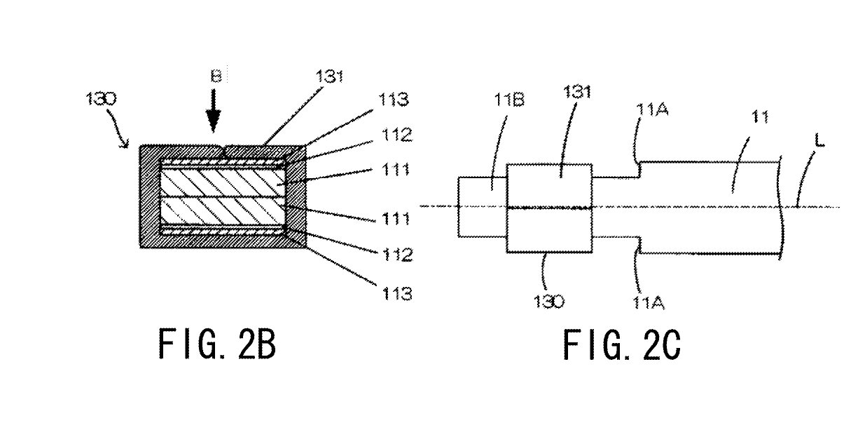

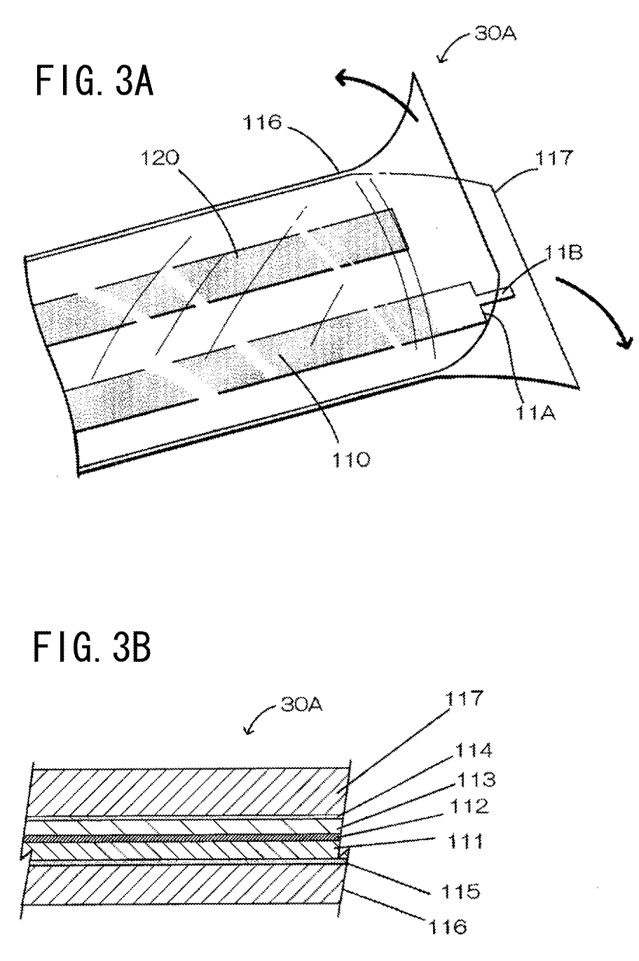

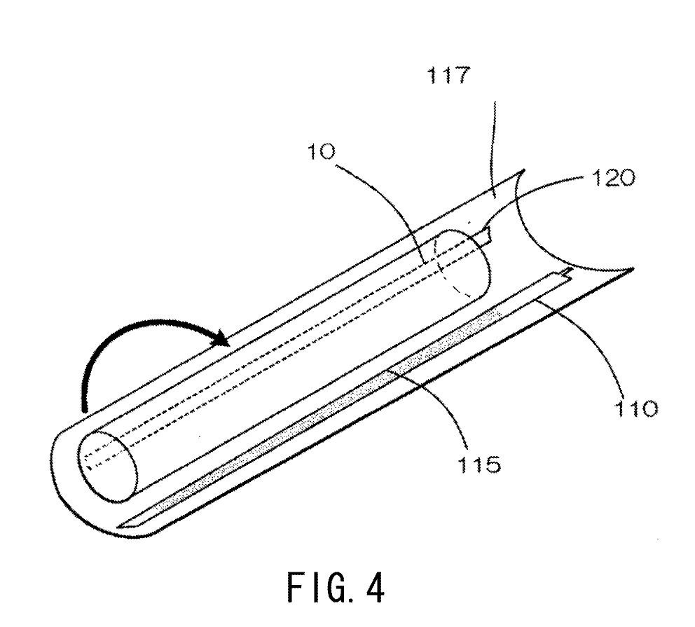

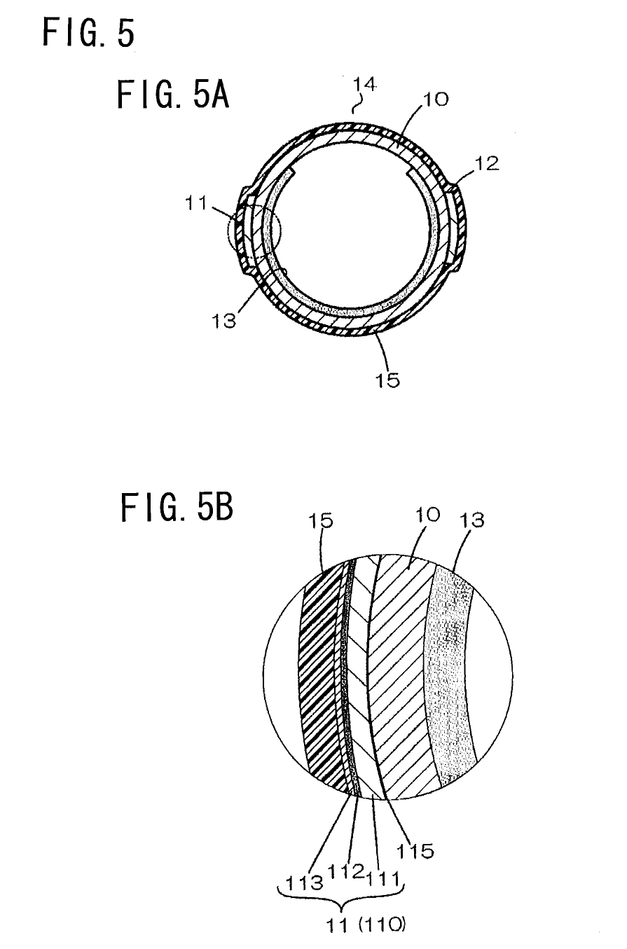

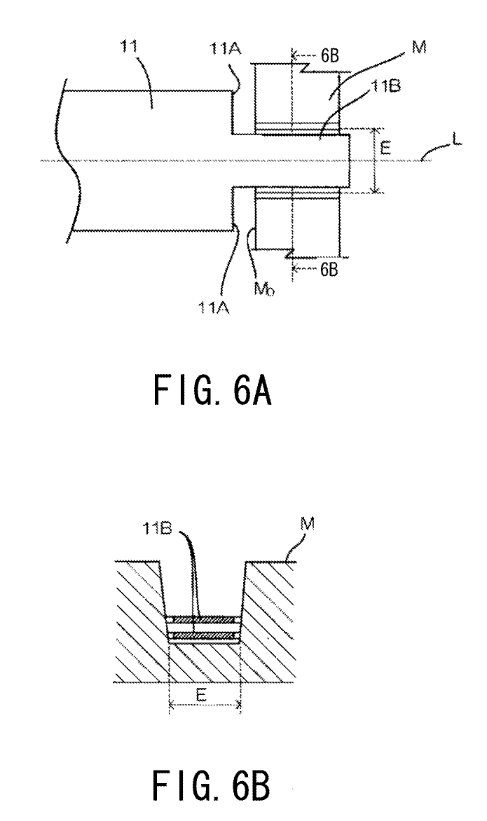

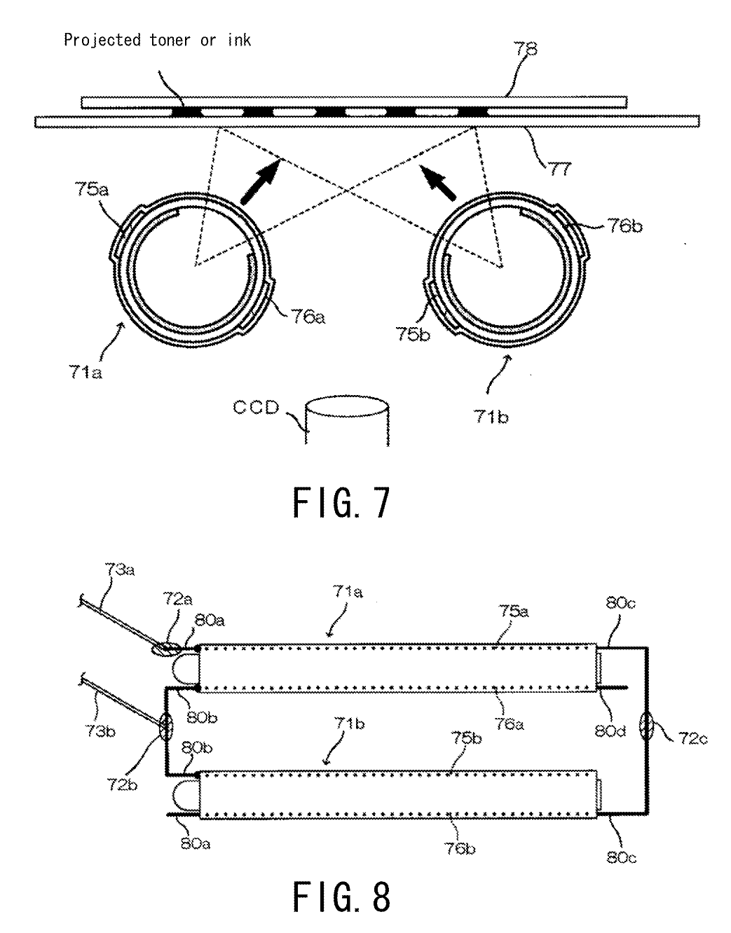

A description of an embodiment according to the present invention will be given below referring to FIGS. 1-6. FIG. 1 is a perspective view showing an overall rare gas discharge lamp apparatus according to the present invention. FIG. 2A is a top plan view of the entire rare gas discharge lamp apparatus according to the present invention. FIG. 2B is an enlarged cross sectional view of a circled portion of FIG. 2A, taken along a line 2B-2B. FIG. 2C is a top plan view of the circled portion of FIG. 2A, wherein the portion is viewed in the direction of an arrow B of FIG. 2B. FIGS. 3A and 3B are explanatory diagrams for explaining a manufacturing process of the present rare gas discharge lamp apparatus. Specifically, FIG. 3A is a perspective view of an example of film electrodes which are used as external electrodes. FIG. 3B is an enlarged sectional view of the electrode portion. Moreover, FIG. 4 is a diagram for explaining a manufacturing process of the rare gas discharge lamp. FIG. 5 is a cross sectional view of the rare gas discharge lamp. FIGS. 6A and 6B are explanatory diagrams for explaining a manufacturing process of the rare gas discharge lamp.

In particular, each of rare gas discharge lamps 100a and 100b shown in FIGS. 1 and 2A are sealed at both ends thereof, and has a cylindrical glass bulb 10 in which rare gas containing xenon gas is enclosed. As shown in the cross sectional view of FIG. 5A, each of the rare gas discharge lamps has external electrodes 11 and 12 which are attached to the outer surface of the glass bulb 10 at almost symmetrical positions with respect to the central axis of the glass bulb 10, and further a sheet or tube shape translucent resin member 15 is arranged over almost the entire length of the glass bulb 10 for insulation of the external electrodes 11 and 12. A light emitting layer 13 on which phosphor is applied is formed on an inner face of the glass bulb 10, and an aperture 14 which is a portion where phosphor is not applied (that is, where light emitting layer 13 is not formed), is formed on the glass bulb 10.

The present rare gas discharge lamp apparatus according to the embodiment is used to irradiate an original document with light. In FIGS. 1 and 2A, a casing 20 of the apparatus is lightweight and consists of resin which has insulation property. The two rare gas discharge lamps 100a and 100b are installed inside the casing 20 and fixed thereto by a fixing member such as a clamp etc. (not shown).

Based on the position of the aperture 14 from which light is emitted, the first rare gas discharge lamp 100a and the second rare gas discharge lamp 100b are fixed so as to be apart from each other at a predetermined distance in the casing 20 and so that the aperture 14 may face a predetermined direction. Since high voltage is impressed to the external electrodes 11 and 12 of the respective rare gas discharge lamps 100a and 100b, in the rare gas discharge lamps 110a and 110b, the first external electrodes 11 are arranged in a center side of the casing 20, and the second external electrodes 12 are arranged in a side face side thereof, so that the potential of the electrodes which are close to each other may be the same. These electrodes 11 and 12 are electrically connected at an end portions in the length direction of the casing 20 respectively, and lead wires 16 and 17 for electric supply are led out of the other end portion of the casing.

A description of an embodiment will be given below, based on a manufacture method of the present rare gas discharge lamp apparatus. FIG. 5B is an enlarged view of a circled portion 5B of the cross sectional view shown in FIG. 5A. Specifically, as shown in FIG. 5B, the external electrodes 11 and 12 are made from metallic foils 111 as basis material. Aluminum is suitable as the material of the metallic foil 111, and the thickness thereof is 20-80 μm (micrometers). Such a metallic foil 111 may be partially cut out or cut off due to tension. Therefore, it is desirable to use the external electrodes 11 and 12 in which to easily perform an operation in a manufacturing process, a resin base material (113) for reinforcement is bonded over the entire region of the metallic foil 111 to be integrated as an electrode structure, so that the strength thereof against tension is improved.

Specifically, as shown in FIG. 5B, the reinforcing member 113 which consists of resin, is bonded through an adhesive layer 112 to the base material of the metallic foil 111, so as to integrally form an external electrode structure 110. The reinforcing member 113 may be made of, for example, polyethylene polyethylene terephthalate (PET), fluorinated-ethylene propylene (4.6 fluoride) (FEP: a copolymer of hexafluoropropylene and tetrafluoroethylene), Perfluoroalkoxyethylene (PFA), polyvinylidenefluoride (2 fluoride) (PVdF), or polyethernitrile (PEN). Such resin is bonded on the metallic foil 111 whose thickness is in a range of 25-75 μm (micrometer), so that it becomes possible to increase the strength thereof against tension thereby suppressing generation of cut-out or cutoff etc., while the flexibility thereof is kept as foil. Where the thickness of the reinforcing member 113 falls below the range so as to be too thin, deflections or creases tend to be produced, so that the tensile strength thereof decreases whereby a reinforcement-function to the metallic foil 111 cannot be expected. On the contrary, when it is too thick, the metallic foil becomes hard to be bent so that the adhesiveness becomes bad since it cannot be bent along the glass bulb. In addition, as an adhesive agent (112) for bonding the reinforcing member 113 on the metallic foil 111, a polyester system, an acrylics system, an urethane system, an epoxy system, a silicone system, or a nitrile rubber system may be used. Since the reinforcing member 113 is integrally formed with the metallic foil 111 by using such an adhesive agent, it is possible to deal with them as a simple member and the intensity thereof against tension can be remarkably increased. Such an electrode structure 110 is attached to the outer surface of the glass bulb 10 through the adhesion agent layer 115.

Such an electrode structure 110 is manufactured in the form of a film-like electrode structure 30A having first and second resin base materials 116 and 117, as shown in FIG. 3. The first and second resin base materials 116 and 117 of this film-like electrode structure 30A is translucent, are made of, for example, polyethylene polyethylene terephthalate (PET), polypropylene, (PP) etc. This film-like electrode structure 30A is manufactured by laminating the adhesion agent 115, the metallic foil 111, the adhesive layer 112, the reinforcing member 113, and an adhesive layer 114 in this order on the first resin base material 116. The electrode structure 110 which forms the first external electrode, and an electrode structure 120 which forms the second external electrode, are apart from each other at a predetermined distance, and are sandwiched between the first and second resin base materials 116 and 117 so as to be in parallel to each other. The first resin base material 116 has the property of being easily separated from the adhesion agent 115. After separating the first resin base material 116 therefrom, it is possible to easily provide the first and second external electrodes 11 and 12 which are apart from each other at a predetermined distance, onto the glass bulb 10, as shown in FIG. 4, by winding a face of the adhesion agent layer 115 around the glass bulb 10.

In the present external electrodes 11 and 12, as understood from FIG. 2C (or FIGS. 4 and 6A), at a predetermined position of an end portion of one side of the first external electrode 11, a narrow part 11B, whose width is narrower than that of the other part, is formed in an outer side thereof, so as to form a step section 11A. This step section 11A is formed approximately symmetrically with respect to a centerline L in the longitudinal direction of the external electrode 11, and is used to connect the first external electrodes 11 of the two rare gas discharge lamps 100a and 100b. A description thereof will be given below in detail.

An example of the specifications of the present rare gas discharge lamps is given to below. The full length in a tube axis direction of the first external electrode 11 including the length up to the end portion of the narrow part 11B, is 350 mm, and that of the second external electrode 12 is 340 mm. Moreover, the width of the first and second external electrodes 11 and 12 (excluding the narrow part) is 3 mm, respectively, and the width of the narrow part formed in the first external electrode is 1.5 mm and the length thereof is 3.0 mm. In addition, referring to FIGS. 3A, 3B, 5A and 5B, the wall thickness (the length in the diameter direction of the glass bulb 10) of the metallic foil 111 in the electrode section structure is 50 μm (micrometers), and the thickness (the length in the diameter direction of the glass bulb 10) of the adhesion agent layer 115 is 30 μm (micrometers). The wall thickness (the length in the diameter direction of the glass bulb 10) of the reinforcing member 113 is 50 μm (micrometers), and the thickness (the length in the diameter direction of the glass bulb 10) of the adhesive agent 112 is 10 μm (micrometers).

The inside diameter of the glass bulb is 5 mm, the outer diameter thereof is 6 mm, and the full length thereof in the direction of the tube axis is 340 mm. In FIG. 4, the first and second external electrodes 11 and 12 are attached to the glass bulb 10 by bonding, so as to project by a length of 4 mm and a length of 12 mm, respectively in the direction of a tube axis from the end portion of the glass bulb.

After the first and second external electrodes 11 and 12 are attached to the glass bulb 10 by bonding, a resin member 15 with a predetermined translucency is attached on these external electrodes. After making such a rare gas discharge lamp, as shown in FIG. 6B, the narrow part 11B of the first electrode 11 of the first rare gas discharge lamps 100a and that of the second rare gas discharge lamp 100b are joined to each other by using a jig M for pressure bonding. In addition, FIG. 6A is a top plan view of the external electrode 11 and the jig M and FIG. 6B is a cross sectional views thereof, taken along a line 6B-6B of FIG. 6A. The jig M is formed so that the width E of an external electrode placement section thereof may agree with that of the narrow part 11B. By bringing the step section 11A of the electrode in contact with a reference face Mo of the jig M, an operator can certainly position the joining part in the length direction of the electrode, with sufficient accuracy. Consequently, they are always joined together with a pressure bonding member in a fixed position, in the length direction of the first external electrode 11, whereby the rare gas discharge lamps 100a and 100b are installed in the casing 20 of the rare gas discharge lamp apparatus, and a distance therebetween can be set so as to be constant so that it is possible to install them in the casing 20 certainly. In the conventional method, when this joining part is displaced in the length direction of the electrode, a surplus portion of the external electrode projected from the glass bulb is too long or too short, so that it becomes difficult to install them in the casing. However, there is no such problem in the present rare gas discharge lamp.

As shown in FIGS. 1 and 2A, the second external electrodes are electrically connected by the lead wire 18 which is formed separately from the electrodes 11 and 12. Since the second external electrodes 12 is antipole with respect to the first electrodes 11, it is also necessary to prevent creeping discharge in a portion of the lead wire 18. In this embodiment, a core wire for power feeder which is in advance put in an insulating member is used as the connecting portion between the second external electrodes 12. Of course, as long as an insulated processing is ensured, it is not limited to the above example. As to the lead wire 18 for connection, an extended section 12A may be formed by projecting the second external electrode 12 in the length direction from each glass bulb, and then the extended sections 12A and terminal portions 18A and 18B of the lead wire 18 are piled and joined by pressure bonding members 132.

As mentioned above, the lead wires 16 and 17 for electric supply are beforehand connected to the first external electrode 11 of the first rare gas discharge lamp 100a and the second external electrode 12 of the second rare gas discharge lamp 100b, respectively and are led out through, for example, an opening 20A formed in part of a side face of the casing 20. Thus, these two rare gas discharge lamps 100a and 100b are installed in the casing 20 in a state where, among the external electrodes 11 and the external electrodes 12, ones having the same potential are mechanically and electrically joined with each other.

Thus, in the rare gas discharge lamp apparatus manufactured in such a way, the first external electrodes 11 extend in the length direction of the respective glass bulbs 10 so as to project from the end portions of the respective glass bulbs 10. The first external electrodes 11 are respectively bended toward the other one of the rare gas discharge lamps 100b and 100a, and a joint portion 130 by the pressure bonding member 131 is approximately arranged in the central part of the casing. FIG. 2B shows a cross sectional view of the joint portion 130, taken along a line 2B-2B of FIG. 2A. In the external electrodes 11, exposed faces (namely, a non adhesive side face of a reinforcing member) of the metallic foils 111 are overlapped so as to be banded together by the pressure bonding member 131. Thus, since the exposed faces of the metallic foils 111 are placed together and joined, poor connection may be prevented so that high reliability of connection state can be acquired, while it is possible to save steps of connecting other lead wires. In addition, since, in each of the first external electrodes 11, the narrow part 11B is formed in an end portion in the longitudinal direction of the electrode 11 and a joint is made in the narrow part 11B, whereby a portion where the joint portion 130 is formed is always fixed to the same place, so that it is possible to certainly install it in the casing 20. The pressure bonding member 131 is carried out as follows. For example, a metal piece is shaped into a U-shape thereby forming a clip. Metal foils and the extended portions of the two first external electrodes 11 and 12 are placed inside the space of the U-shape metal clip, and then they are crushed by applying pressure from circumference of the clip, thereby mechanically fixing them and forming electric conduction thereof.

Since in the two rare gas discharge lamps, as mentioned above, the external electrodes of the rare gas discharge lamps, to which voltage having the same potential is impressed, are connected to each other, the electric junction can be maintained in a good state so that it is possible to offer a rare gas discharge lamp apparatus having good yield.

As mentioned above, when the external electrodes are formed by foil-like metal, since the foil can be bended along the outer surface of the glass bulb even if the outer diameter of the glass bulb is a small, for example, 6 mm, the external electrode can be brought in close contact with a tube wall without generating a gap between the tube wall and the external electrode. In addition, it becomes possible to place and join the metallic foils together with each other. Furthermore, since the narrow part is formed in the predetermined position of the end portion area of the metallic foil, the joint portion by the pressure bonding member is formed in a fixed position in a length direction of the electrode, whereby the distance of two rare gas discharge lamps is always fixed to the same position, so that it is possible to certainly install it in the casing. Moreover, since the reinforcing member is brought into close contact with the metallic foil which forms an external electrode, it is hard to be torn to pieces, so that the yield thereof can be remarkably improved at the time of the manufacture.

The preceding description has been presented only to illustrate and describe exemplary embodiments of the present rare gas discharge lamp apparatus. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A rare gas discharge lamp apparatus, comprising:
two or more rare gas discharge lamps aligned in parallel, each of which has a glass bulb that contains rare gas therein, and first and second external electrodes that are formed on an outer surface of the glass bulb, extends in a glass bulb length direction, and are arranged apart from each other;
wherein the first and second external electrodes are made from metallic foils, and project in an outer length direction of the glass bulb from the respective glass bulbs to form extended portions, and
wherein the first external electrode of one of the two or more rare gas discharge lamps and that of another one of the two or more rare gas discharge lamps are joined by a pressure bonding member at the extended portions of the respective first external electrodes.

2. The rare gas discharge lamp apparatus according to claim 1, the first external electrode of each of the two or more rare gas discharge lamps has a step portion where a narrow part whose width is shorter than the other part, is formed at the extended portion, and wherein the first electrodes are joined at the narrow parts by the pressure bonding member.

3. The rare gas discharge lamp apparatus according to either claim 1, wherein a reinforcing member made of resin is formed on one face of the metallic foil forming the external electrode, through an adhesive agent layer, and
wherein a non adhesive side face of the reinforcing member of the first external electrode of the one of the two or more rare gas discharge lamps and that of the reinforcing member of the another one of the two or more rare gas discharge lamps are brought into contact with each other and then the first external electrodes are joined by the pressure bonding member.

4. The rare gas discharge lamp apparatus according to either claim 2, wherein a reinforcing member made of resin is formed on one face of the metallic foil forming the external electrode, through an adhesive agent layer, and
wherein a non adhesive side face of the reinforcing member of the first external electrode of the one of the two or more rare gas discharge lamps and that of the reinforcing member of the another one of the two or more rare gas discharge lamps are brought into contact with each other and then the first external electrodes are joined by the pressure bonding member.

5. The rare gas discharge lamp apparatus according to claim 3, wherein the reinforcing member is made of resin whose thickness is 25-75 μm.

6. The rare gas discharge lamp apparatus according to claim 4, wherein the reinforcing member is made of resin whose thickness is 25-75 μm.
